(19) United States
(12) Patent Application Publication
(10) Pub. No.: US 2017/0335734 A1
(43) Pub. Date: Nov. 23, 2017

(54) Tempering Air System For Gas Turbine Selective Catalyst Reduction System

(71) Applicant: General Electric Company, Schenectady, NY (US)

(72) Inventors: Ali Mustapha Tabikh, Vaxjo (SE); John Buschmann, Knoxville, TN (US); Lawrence Joseph Czarnecki, Knoxville, TN (US); Lars-Erik Johansson, Almeboda (SE)

(21) Appl. No.: 15/158,873

(22) Filed: May 19, 2016

(51) Int. Cl. F01N 3/20; F01N 3/05; F01N 3/28; F02C 3/04

(52) U.S. Cl. CPC F01N 3/2066; F02C 3/04; F01N 3/05; F01N 3/2892; F05D 2220/32

(57) ABSTRACT

The present application provides a selective catalyst reduction system for use with a combustion gas stream of a gas turbine. The selective catalyst reduction system may include a tempering air system with a finger mixer and a number of mixer plates and a catalyst positioned downstream of the tempering air system. The tempering air system cools the combustion gas stream and evens out the temperature profile before the combustion gas stream reaches the catalyst.

### TECHNICAL FIELD

The present application and the resultant patent relate generally to gas turbine engines and more particularly relate to a tempering air system for reducing the temperature of hot combustion gases for use in a gas turbine selective catalyst reduction system.

### BACKGROUND OF THE INVENTION

In the combustion process of a gas turbine engine, nitrogen oxides and other types of regulated emissions are produced. One solution for reducing the overall levels of nitrogen oxide emissions is the use of a selective catalyst reduction system. Generally described, the selective catalyst reduction system adds a reductant, typically ammonia or urea, to the combustion gas stream before passing the stream through a catalyst bed so as to absorb selectively the nitrogen oxides and the reducing agent. The absorbed components undergo a chemical reaction on the catalyst surface and the reaction products are desorbed. Specifically, the reactant reacts with the nitrogen oxides in the combustion gas stream to form water and nitrogen. Other types of catalysts and other types of reductants may be used.

The overall efficiency of the selective catalyst reduction system may depend in part on the temperature of the combustion gas stream. Specifically, the efficient temperature range of the selective catalyst reduction system may be relatively narrow. As such, the hot combustion gas stream generally should be cooled before reaching the catalyst. Moreover, the gas stream should reach an even temperature profile upstream of the catalyst.

### SUMMARY OF THE INVENTION

The present application and the resultant patent provide a selective catalyst reduction system for use with a combustion gas stream of a gas turbine. The selective catalyst reduction system may include a tempering air system with a finger mixer and a number of mixer plates and a catalyst positioned downstream of the tempering air system. The tempering air system cools the combustion gas stream and evens out the temperature profile before the combustion gas stream reaches the catalyst.

The present application and the resultant patent further provide a method of operating a selective catalyst reduction system with a combustion gas stream of a gas turbine engine. The method may include the steps of flowing the combustion gas stream into the selective catalyst reduction system, injecting a cooling air stream into the combustion gas stream, mixing the combustion gas stream and the cooling air stream in a number of mixer plates, and reacting the mixed stream in a catalyst.

The present application and the resultant patent further provide a tempering air system for use with a combustion gas stream entering a selective catalyst reduction system. The tempering air system may include a cooling air stream, a finger mixer for injecting the cooling air stream into the combustion gas stream, and a number of mixer plates positioned downstream of the finger mixer to mix the cooling air stream and the combustion gas stream into a substantially uniform profile.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, a turbine, a load, and a selective catalyst reduction system.

FIG. 2 is a partial perspective view of a selective catalyst reduction system as may be described herein.

FIG. 3 is a side plan view of a finger mixer that may be used with the selective catalyst reduction system of FIG. 2.

FIG. 4 is a partial perspective view of a triangular/elliptical mixer that may be used with the selective catalyst reduction system of FIG. 2.

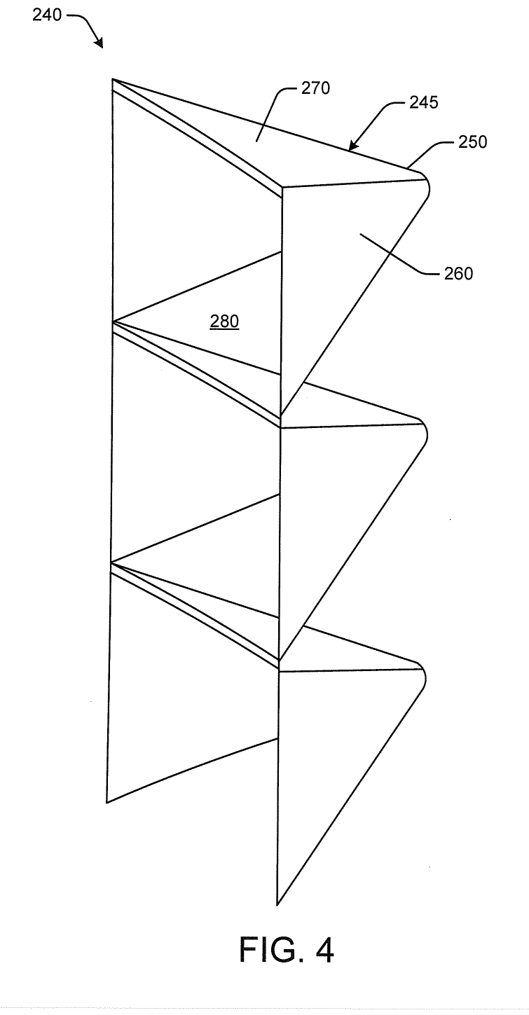

### DETAILED DESCRIPTION

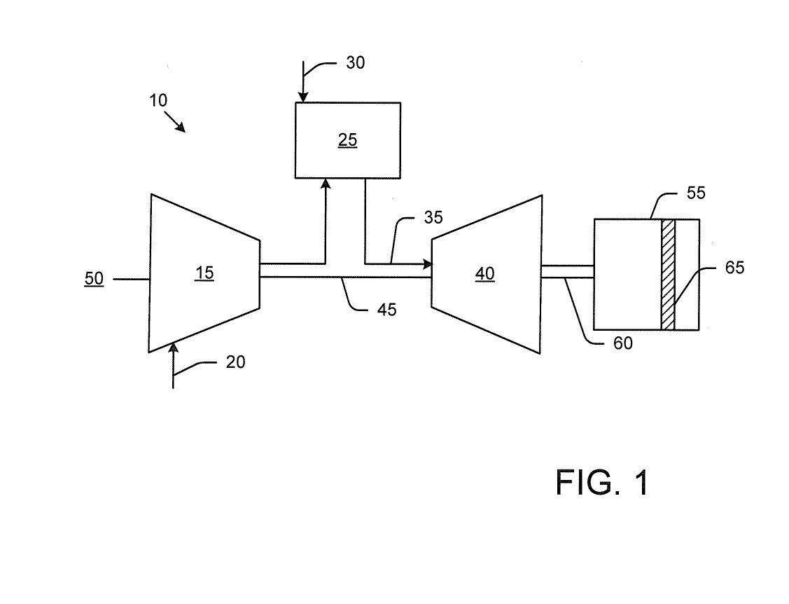

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25 positioned in a circumferential array and the like. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, liquid fuels, and/or other types of fuels and blends thereof. The gas turbine engine 10 may have different configurations and may use other types of components. Other types of gas turbine engines also may be used herein. Multiple gas turbine engines, other types of turbines, and other types of power generation equipment also may be used herein together.

The gas turbine engine 10 also may include a selective catalyst reduction system 55. The selective catalyst reduction system 55 may be positioned downstream of the turbine 40 and may be in communication via a length of ducting 60 and the like. As described above, the selective catalyst reduction system 55 may include a catalyst 65 therein so as to react with the combustion gas stream 35. Many different types of selective catalyst reduction system 55 and catalysts 65 may be used herein.

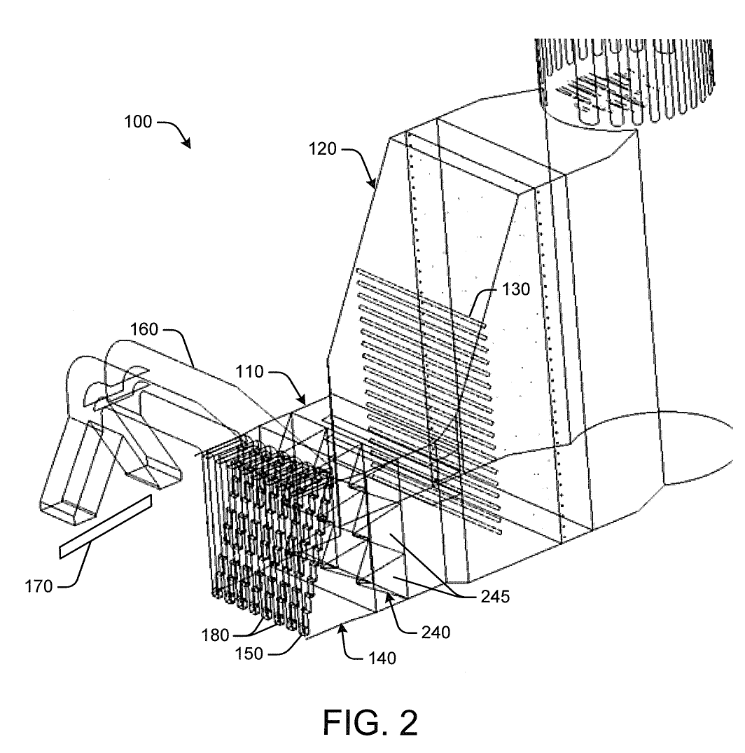

FIG. 2 shows a schematic diagram of an example of a selective catalyst reduction system 100 as may be described herein. The selective catalyst reduction system 100 may be used with the gas turbine engine 10 and the like. The selective catalyst reduction system 100 may include an inlet section 110. The inlet section 110 may be in communication with the combustion gas stream 35 from the turbine 40 via the ducting 60 and the like. The inlet section 110 may have any suitable size, shape, or configuration. The inlet section 110 may lead to a diffuser section 120. The diffuser section 120 may direct the combustion gas stream 35 through a casing of progressively increasing cross sectional area in the direction of the flow with increased static pressure. The diffuser section 120 may have any suitable size, shape, or configuration. A catalyst 130 may be positioned about the diffuser section 120. The catalyst 130 may be of conventional design and may be manufactured from suitable carrier and active catalytic components. Different types of catalysts 130 may be used herein. The catalyst 130 may have any suitable size, shape, or configuration. An injector (not shown) may be positioned about the catalyst 130 so as to inject a reductant into the combustion gas stream 35. Other components and other configurations may be used herein.

The selective catalyst reduction system 100 also may include a tempering air system 140. The tempering air system 140 may be positioned about the inlet section 110 in line with the incoming combustion gas stream 35. The tempering air system 140 may reduce the temperature of the combustion gas stream 35 before the stream 35 reaches the catalyst 130.

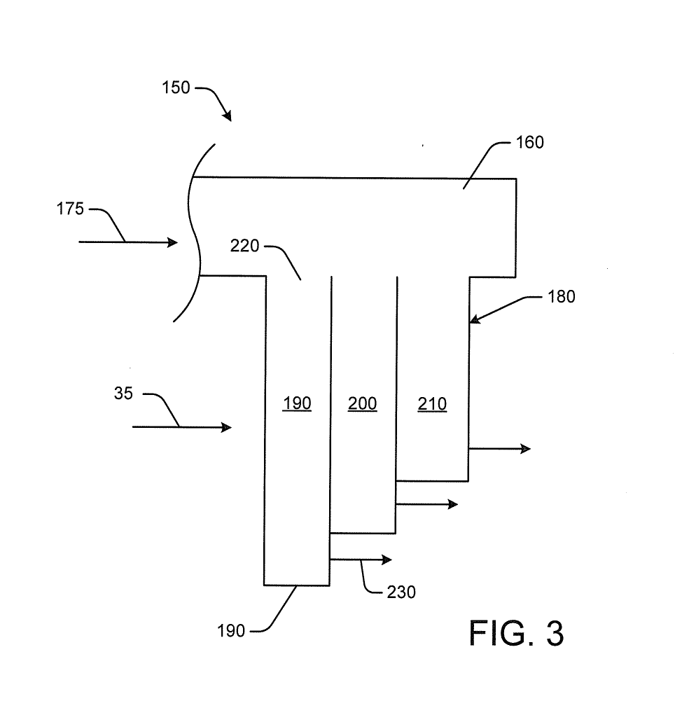

The tempering air system 140 may include a finger mixer 150. Generally described, the finger mixer 150 may include a number of finger-like elements protruding into the combustion gas stream 35. As is shown in FIG. 3, the finger mixer 150 may include an inlet air duct 160. The inlet air duct 160 may be in communication with an air supply 170 or other type of air movement device so as to provide a cooling air stream 175. The air supply 170 may be of conventional design and may have any suitable size, shape, or capacity.

The inlet air duct 160 of the finger mixer 150 may be in communication with a number of finger ducts 180. In this example, a first finger duct 190, a second finger duct 200, and a third finger duct 210 are shown, although any number of the finger ducts 180 may be used herein. The finger ducts 180 may be in the form of tubular elements with a rectangular or a square cross-sectional shape and the like. The finger ducts 180 may be arranged adjacent to each other. The finger ducts 180 may have a progressively reduced length with the first finger duct 190 being the longest and, hence, penetrating further into the flow of the combustion gas stream 35 as compared to the following finger ducts 180. As is shown, the assembly array of the finger ducts 180 may have a substantially triangular configuration and the like. Each of the finger ducts 180 may have an inlet 220 in communication with the inlet air duct 160 and an outlet 230 positioned about the combustion gas stream 35 so to inject the cooling air stream 175 therein. Multiple outlets 230 also may be used along the length of each of the finger ducts 180. The finger ducts 180 may have any suitable size, shape, or configuration. Other components and other configurations may be used herein.

The tempering air system 140 also may include a triangular-elliptical mixer 140. The triangular-elliptical mixer 140 may be positioned downstream of the finger mixer 150. The triangular-elliptical mixer 140 may include a number of mixer plates 245. The mixer plates 245 may have an open, substantially triangular or elliptical-like configuration 250. Specifically, each of the mixer plates 245 may include a pair of triangular side plates 260 with an open top end 270 and an open bottom end 280. Alternatively, the side ends 260 may be open with a triangular top plate 270 and a triangular bottom plate 280. Other alternatives may be used herein. The mixer plates 245 may have any suitable size, shape, or configuration. Any number of the mixer plates 245 may be used herein. The mixer plates 245 may be stacked to any suitable height with any suitable number of rows and columns. Any shape causing the gas stream to deviate may be used herein. Other components and configurations may be used herein.

In use, the hot combustion gas stream 35 from the turbine 40 enters the inlet section 110 of the selective catalyst reduction system 100 via the ducting 60. The hot combustion gas stream 35 passes through and around the finger ducts 180 of the finger mixer 150 while the cooling air stream 175 from the air supply 170 and the inlet duct 160 is injected into the combustion gas stream 35 through the outlets 230 of the finger ducts 180. The combustion gas stream 35 and the cooling air stream 175 thus mix so as to reduce the overall stream temperature. Such mixing is further promoted as the combustion gas stream 35 and the cooling air stream 175 flow through the mixer plates 245 of the triangular-elliptical mixer 240. Moreover, the triangular-elliptical mixer 240 also evens out the temperature profile of the flow. The now cooled combustion gas stream 35 then may pass into the diffuser section 120 and through the catalyst 130 for reaction therewith.

The selective catalyst reduction system 100 with the tempering air system 140 thus cools the combustion gas stream 35 from the turbine 40 to within an appropriate temperature range for efficient use with the catalyst 130. Specifically, the finger mixer 150 injects the appropriate volume of the cooling air stream 175 while the triangular-elliptical mixer 140 240 stabilizes the flow and improves the overall flow distribution to the catalyst 130. The tempering air system 140 also may be used in processes other than a selective catalyst reduction system that may require cooling a flow with an even flow profile.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A selective catalyst reduction system for use with a combustion gas stream of a gas turbine, comprising:
a tempering air system;
the tempering air system comprising a finger mixer and a plurality mixer plates; and
a catalyst positioned downstream of the tempering air system;
wherein the tempering air system cools the combustion gas stream before the combustion gas stream reaches the catalyst.

2. The selective catalyst reduction system of claim 1, wherein the finger mixer of the tempering air system injects a cooling air stream into the combustion gas stream.

3. The selective catalyst reduction system of claim 2, wherein the finger mixer comprises an air supply for the cooling air stream.

4. The selective catalyst reduction system of claim 3, wherein the finger mixer comprises an inlet air duct in communication with the air supply.

5. The selective catalyst reduction system of claim 4, wherein the finger mixer comprises a plurality of finger ducts.

6. The selective catalyst reduction system of claim 5, wherein the plurality of finger ducts comprises an inlet in communication with the air inlet duct and an outlet for injecting the cooling air stream into the combustion gas stream.

7. The selective catalyst reduction system of claim 1, wherein the finger mixer comprises a plurality of finger ducts of progressively reduced length.

8. The selective catalyst reduction system of claim 7, wherein the plurality of finger ducts comprises a substantial triangular configuration.

9. The selective catalyst reduction system of claim 1, wherein the plurality of mixer plates comprises a pair of triangular side plates.

10. The selective catalyst reduction system of claim 1, wherein the plurality of mixer plates comprises a triangular top plate and triangular bottom plate.

11. The selective catalyst reduction system of claim 1, wherein the plurality of mixer plates is arranged in a plurality of columns and a plurality of rows.

12. The selective catalyst reduction system of claim 1, wherein the plurality of mixer plates comprises a triangular and/or an elliptical configuration.

13. The selective catalyst reduction system of claim 1, wherein the tempering air system is positioned about an inlet section.

14. The selective catalyst reduction system of claim 13, wherein the catalyst is positioned about a diffuser section.

15. A method of operating a selective catalyst reduction system with a combustion gas stream of a gas turbine engine, comprising:
flowing the combustion gas stream into the selective catalyst reduction system;
injecting a cooling air stream into the combustion gas stream;
mixing the combustion gas stream and the cooling air stream in a plurality of mixer plates; and
reacting the mixed stream with a catalyst.

16. A tempering air system for use with a combustion gas stream entering a selective catalyst reduction system, comprising:
a cooling air stream;
a finger mixer for injecting the cooling air stream into the combustion gas stream; and
a plurality of mixer plates positioned downstream of the finger mixer to mix the cooling air stream and the combustion gas stream into a substantially uniform profile.

17. The tempering air system of claim 16, wherein the finger mixer comprises an air supply for the cooling air stream.

18. The tempering air system of claim 16, wherein the finger mixer comprises a plurality of finger ducts of progressively reduced length.

19. The tempering air system of claim 16, wherein the plurality of mixer plates comprises a pair of triangular side plates or a triangular top plate and a triangular bottom plate.

20. The tempering air system of claim 16, wherein the plurality of mixer plates comprises a triangular and/or an elliptical configuration.
